(19) United States
(12) Patent Application Publication
(10) Pub. No.: US 2017/0081738 A1
(43) Pub. Date: Mar. 23, 2017

(54) METHOD & METAL COMPONENT

(71) Applicant: Aktiebolaget SKF, Goteborg (SE)

(72) Inventors: Anna Isabella Flodstrom, Goeteborg (SE); Staffan Larsson, Goeteborg (SE)

(73) Assignee: Aktiebolaget SKF, Goteborg (SE)

(21) Appl. No.: 15/311,412

(22) PCT Filed: Jun. 5, 2015
(86) PCT No.: PCT/SE2015/050656

§ 371 Date: Nov. 15, 2016

(30) Foreign Application Priority Data
Jun. 27, 2014 (SE) 1450792-5

(51) Int. Cl. C21D 9/36; C21D 9/38; F16C 33/64; C21D 1/42; C23C 8/22; C23C 8/32; C21D 9/40; C21D 1/06

(52) U.S. Cl. CPC C21D 9/36; C21D 9/40; C21D 9/38; C21D 1/06; C21D 1/42; C23C 8/22; C23C 8/32; F16C 33/64; C22C 38/44

(57) ABSTRACT

A method for surface hardening at least one part of a surface of a metal component is provided. The steps include a) enriching the at least one part of a surface of a metal component with at least one of carbon and nitrogen, and b) induction hardening the at least one part of the surface of the metal component.

### CROSS REFERENCE TO RELATED APPLICATIONS

This is a United States National Stage Application claiming the benefit of International Application Number PCT/SE2015/050656 filed on Jun. 5, 2015, which claims the benefit of Swedish Patent Application 1450792-5 filed on Jun. 27, 2014, both of which are incorporated herein by reference in their entireties.

### FIELD OF THE INVENTION

The present invention concerns a method for surface hardening at least one part of a surface of a metal component. The present invention also concerns a metal component that has been subjected to such a method.

### BACKGROUND OF THE INVENTION

Carburizing, carbonitriding and induction hardening are surface hardening treatments that may be used to produce a hard, wear-resistant layer (case) on the surface of a metal component.

Carburizing is a heat treatment process in which iron or steel is heated in the presence of another solid, liquid or gas material, which liberates carbon as it decomposes. The surface or case will have higher carbon content than the original material. When the iron or steel is cooled rapidly by quenching, the high carbon content surface becomes hard, while the core remains soft (i.e. ductile) and tough.

Carbonitriding is a metallurgical surface modification technique in which atoms of carbon and nitrogen diffuse interstitially into the metal, creating barriers to slip and increasing the hardness near the surface, typically in a layer that is 0.1 to 0.3 mm thick. Carbonitiriding can also be used to create carbides or nitrides, primarily to avoid or reduce grain growth and to reduce abrasive wear. Carbonitriding is usually carried out a temperature of 850-860° C.

Induction hardening is a heat treatment in which a metal component is heated to the ferrite/austenite transformation temperature or higher by induction heating and then quenched. The quenched metal undergoes a martensitic transformation, increasing the hardness and brittleness of the surface of the metal component. Induction hardening may be used to selectively harden areas of a mechanical component without affecting the properties of the component as a whole.

### BRIEF SUMMARY OF THE INVENTION

An object of the invention is to provide an improved method for surface hardening at least one part of a surface of a metal component.

This object is achieved by a method that provides the steps of a) enriching the at least one part of a surface of a metal component with carbon and/or nitrogen, and b) induction hardening the at least one part of the surface of the metal component.

It has been found that this combination of surface enrichment (step a)) and induction hardening (step b)) provides a metal component having increased surface hardness and increased compressive residual stresses, and thereby improved fatigue properties compared to the surface hardness of a metal component that has been subjected only to surface enrichment (only step a)) or only induction hardening (only step b)). Additionally, the method according to the present invention is faster than a surface hardening method using only case carburizing when hardening deep hardening depths, i.e. depths greater than 2 mm from the surface of a metal component.

A metal component that has been subjected to a method according to an embodiment of the present invention may contain a region that has only been induction hardened, but which has not been subjected to surface enrichment, and which may therefore have a lower carbon content than in a case carburized sample with the same hardening depth which results in reduced brittleness in this region.

It should be noted that the induction hardening step b) is preferably carried out (directly or indirectly) after the surface enrichment step a) since the re-hardening of the case that takes place during induction hardening results in reduced grain size and thereby improved fatigue properties.

According to an embodiment of the invention step a) includes either case carburizing or carbonitriding the at least one part of the surface of the metal component.

According to another embodiment of the invention the method provides the step of tempering the at least one part of the surface of the metal component in between the surface enrichment step a) and the induction hardening step b). Such intermediate tempering has been found to result in increased compressive residual stresses which increase the metal component's fatigue strength and service life since it is more difficult for cracks to initiate or propagate in a compressively stressed zone. Compressive stresses are namely beneficial in increasing resistance to fatigue failures, corrosion fatigue, stress corrosion cracking, hydrogen assisted cracking, fretting, galling and erosion caused by cavitation. Tempering after induction hardening can thereby counteract brittleness caused by the surface enrichment step.

According to a further embodiment of the invention the method provides the step of tempering the at least one part of the surface of the metal component after both of the steps a) and b) have been carried out, preferably directly or indirectly after the induction hardening step b). Such a final tempering step has been found to result in a decreased risk of cracking, a reduced amount of austenite, lower surface hardness and reduced compressive residual stresses.

According to an embodiment of the invention the method provides the step of deep cooling the at least one part of the surface of the metal component to below −20° C. after both of the steps a) and b) have been carried out, preferably after the induction hardening step b). Such deep cooling has been found to result in reduced retained austenite levels, increase compressive residual stresses and increased surface hardness.

According to another embodiment of the invention the surface enrichment step a) is followed by martensitic or bainitic quenching or cooling.

According to a further embodiment of the invention the induction hardening step b) is followed by martensitic or bainitic quenching.

According to an embodiment of the invention the metal component constitutes at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength. The metal component may include or constitute gear teeth, a cam, shaft, bearing, fastener, pin, automotive clutch plate, tool, or a die. The metal component may be used in automotive wind, marine, metal producing or other machine applications which require high wear resistance and/or increased fatigue and/or tensile strength.

According to another embodiment of the invention the metal component provides steel containing 0.5-5.0 weight-% Cr, 0.1-5.0 weight-% Mo and 0.1-1.1 weight-% C, the remainder being Fe and optionally any one or more of the following Si, Mn, Ni, and/or V, and normally occurring impurities.

According to a further embodiment of the invention the metal component provides one of the following steels: C56E2, 42CrMo4, 50CrMo4, 20NiCrMo7, 16MnCr5, 18NiCrMo14-6, 18NiCrMo7-6 a high carbon bearing steel grade, such as 100Cr6.

According to an embodiment of the invention the metal component has a case depth (i.e. a case hardening or carbonitriding depth) up to 1+Dw/30 mm where Dw is the maximum transverse dimension of the metal component in millimeters, a surface carbon content of 0.5-2.5 weight-% and/or a surface nitrogen content of 0-1 weight-%, and an induction hardening depth of up to 1.3*(1+Dw/30) mm after being subjected to the method.

According to another embodiment of the invention the metal component has residual stresses lower than −300 MPa at a depth of 0-0.5 mm below its surface after being subjected to the method.

The present invention also concerns a metal component that has a case depth up to 1+Dw/30 mm where Dw is the maximum transverse dimension of the metal component in millimeters, a surface carbon content of 0.5-2.5 weight-% and/or a surface nitrogen content of 0-1 weight-%, and an induction hardening depth of up to 1.3*(1+Dw/30) mm. Such a metal component may be provided using a method according to any of the embodiments of the invention.

According to an embodiment of the invention the metal component has residual stresses lower than −300 MPa at a depth of 0-0.5 mm below its surface after being subjected to the method.

According to another embodiment of the invention the metal component provides steel containing 0.5-5.0 weight-% Cr, 0.1-5.0 weight-% Mo and 0.1-1.1 weight-% C, the remainder being Fe and optionally any one or more of the following Si, Mn, Ni, and/or V, and normally occurring impurities.

According to a further embodiment of the invention the metal component provides one of the following steels: C56E2, 42CrMo4, 50CrMo4, 20NiCrMo7, 16MnCr5, 18NiCrMo14-6, 18NiCrMo7-6 a high carbon bearing steel grade, such as 100Cr6.

According to an embodiment of the invention the metal component constitutes at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength. The metal component may include or constitute gear teeth, a cam, shaft, bearing, fastener, pin, automotive clutch plate, tool, or a die.

The metal component may be used in automotive, wind, marine, metal producing or other machine applications which require high wear resistance and/or increased fatigue and/or tensile strength.

### BRIEF DESCRIPTION OF THE SEVERAL VIEWS OF THE DRAWING

The present invention will hereinafter be further explained by means of non-limiting examples with reference to the appended schematic figures where;

FIG. 1 shows the steps of a method according to an embodiment of the invention,

FIG. 2 shows a metal component according to an embodiment of the invention,

FIG. 3 shows the hardness of a metal component subjected to a method according to an embodiment of the invention compared with the hardness of metal components subjected to surface hardening treatments according to the prior art,

FIG. 4 shows the residual stresses of a metal component subjected to a method according to an embodiment of the invention compared with the residual stresses of metal components subjected to surface hardening treatments according to the prior art,

FIGS. 5 & 6 show the effect of intermediate tempering on the hardness and residual stresses of a metal component subjected to a method according to an embodiment of the invention,

FIGS. 7 & 8 show the effect of final tempering on the hardness and residual stresses of a metal component subjected to a method according to an embodiment of the invention, and

FIGS. 9 & 10 show the effect of using carbonitriding instead of case carburizing in step a) of a method according to the present invention on the hardness and residual stresses of a metal component subjected to such a method.

It should be noted that the drawings have not been drawn to scale and that the dimensions of certain features have been exaggerated for the sake of clarity.

### DETAILED DESCRIPTION OF THE INVENTION

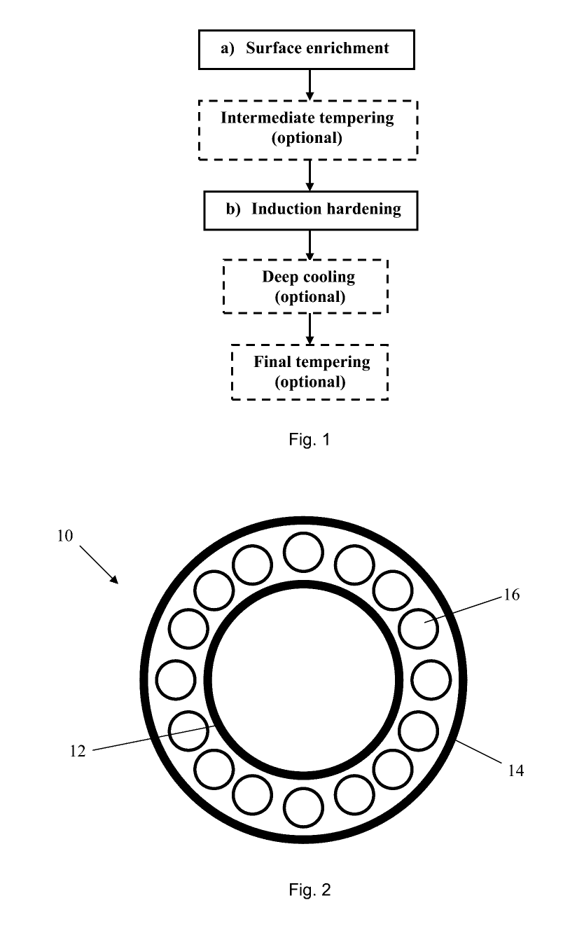

FIG. 1 shows a method for surface hardening at least one part of a surface of a metal component, according to an embodiment of the present invention. The method provides the steps of a) enriching the at least one part of a surface of a metal component with carbon and/or nitrogen, and then directly or indirectly b) induction hardening the at least one part of the surface of the metal component.

The surface enrichment step a) may include case carburizing the at least one part of the surface of the metal component followed by martensitic or bainitic quenching or cooling. Alternatively, the surface enrichment step a) may include carbonitriding the at least one part of the surface of the metal component followed by martensitic or bainitic quenching. Changing the microstructure of the surface of the metal component using such surface enrichment may improve it wear resistance, corrosion resistance, load bearing capacity, surface hardness, core hardness, compound layer thickness, abrasive wear, adhesive wear, and/or fatigue resistance and enhances its ability to relax stress concentration at the edges of any indentations in its surface.

The induction hardening step b) may also be followed by martensitic or bainitic quenching.

Optionally, the method provides the step of tempering the at least one part of the surface of the metal component in between the surface enrichment step a) and the induction hardening step b). Such intermediate tempering may be carried out in a furnace or by means of induction tempering. Intermediate tempering may be carried out for 4 hours at a temperature of 390° C. for example or for any other suitable time and at any other suitable temperature.

Optionally, the method provides the step of deep cooling the at least one part of the surface of the metal component to below −20° C. after both of the steps a) and b) have been carried out.

Optionally, the method provides the step of tempering the at least one part of the surface of the metal component after both of the steps a) and b) have been carried out. Such final tempering may be carried out in a furnace or by means of induction tempering. Final tempering may be carried out for 1 hour at a temperature of 160° C. for example or for any other suitable time and at any other suitable temperature.

A method according to an embodiment of the present invention may be used to provide a metal component that has a case depth up to 1+Dw/30 mm, where Dw is the maximum transverse dimension of the metal component in millimeters, for example the diameter of a rolling element, a surface carbon content of 0.5-2.5 weight-% or 0.5-1.5 weigh-%, and/or a surface nitrogen content of 0-1 weight-% or 0-0.4 weight-%, and an induction hardening depth of up to 1.3*(1+Dw/30) mm after being subjected to the method.

FIG. 2 shows an example of a metal component according to an embodiment of the invention, namely a rolling element bearing 10 that may range in size from 10 mm diameter to a few meters diameter and have a load-carrying capacity from a few tens of grams to many thousands of tons. The metal component 10 according to the present invention may namely be of any size and have any load-carrying capacity. The illustrated bearing 10 has an inner ring 12 and an outer ring 14 and a set of rolling elements 16. The inner ring 12, the outer ring 14 and/or the rolling elements 16 of the rolling element bearing 10, and preferably at least part of the surface of all of the rolling contact parts of the rolling element bearing 10 may be subjected to a method according to the present invention.

The metal component may provides steel containing 0.5-5.0 weight-% Cr, 0.1-5.0 weight-% Mo and 0.1-1.1 weight-% C, the remainder being Fe and optionally any one or more of the following Si, Mn, Ni, and/or V, and normally occurring impurities.

According to an embodiment of the invention the metal component provides steel containing 0.5-2.0 weight-% Cr, 0.1-0.5 weight-% Mo and 0.1-1.1 weight-% C the remainder being Fe and optionally any one or more of the following Si, Mn, Ni, and/or V, and normally occurring impurities.

According to another embodiment of the invention the metal component provides steel containing 0.5-0.7 weight-% C and less than 1 weight-% Mn, the remainder being Fe and optionally any one or more of the following Cr, Mo, Si, Ni, and/or V, and normally occurring impurities.

According to a further embodiment of the invention the metal component provides steel containing less than 0.2 weight-% C, 4.0-4.5 weigh-% Cr, 4.0-4.5 weight-% Mo, 3.0-4.0 weight-% Ni and 1.0-1.5 weight-% V, the remainder being Fe and optionally any one or more of the following Si, and/or Mn, and normally occurring impurities.

The metal component may provide one of the following steels: C56E2, 42CrMo4, 50CrMo4, 20NiCrMo7, 16MnCr5, 18NiCrMo14-6, 18NiCrMo7-6 a high carbon bearing steel grade, such as 100Cr6.

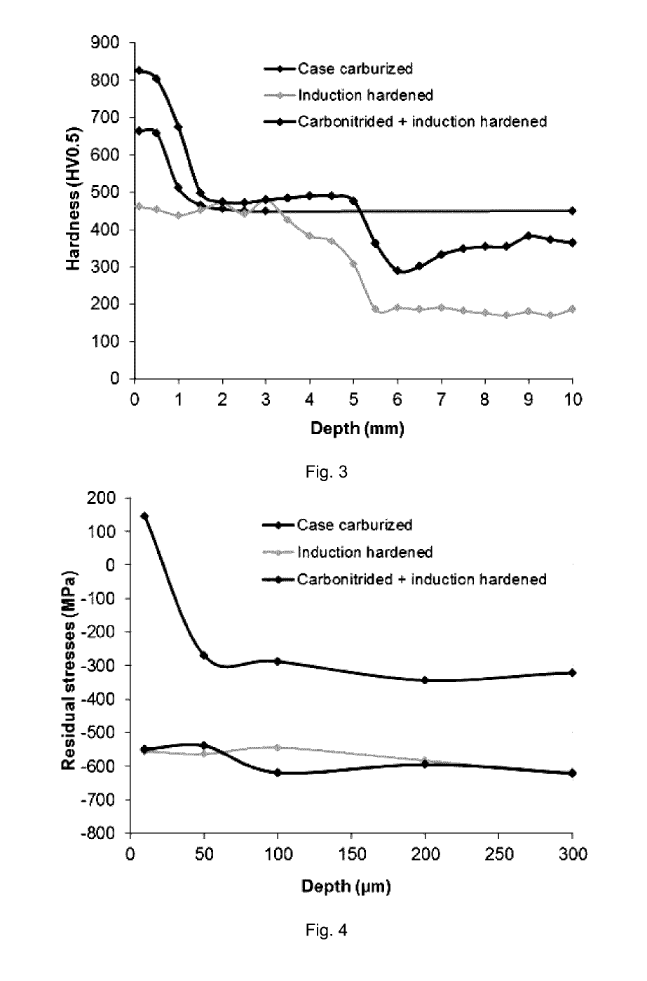

FIGS. 3-10 show experimental data collected after subjecting metal components comprising 18CrNiMo7-6 to a method according to embodiments of the present invention.

FIG. 3 shows the harness of a metal component subjected to a method according to an embodiment of the invention compared with the hardness of metal components subjected to surface hardening treatments according to the prior art, namely metal components subjected to only case carburizing and only induction hardening. It can be seen that the method according to the present invention provides a metal component having a surface hardness that is greater than the surface hardness achieved using only case carburizing or only induction hardening.

The surface of a metal component subjected to a method according to the present invention may be provided with a surface hardness of 700-1000 HV, and a core hardness of 200-550 HV depending on the grade of steel used.

FIG. 4 shows the residual stresses of a metal component subjected to a method according to an embodiment of the invention compared with the residual stresses of metal components subjected to surface hardening treatments according to the prior art, namely metal components subjected to only case carburizing and only induction hardening. It can be seen that the method according to the present invention provides a metal component having residual stresses that are greater than the residual stresses of metal components subjected to case carburizing only.

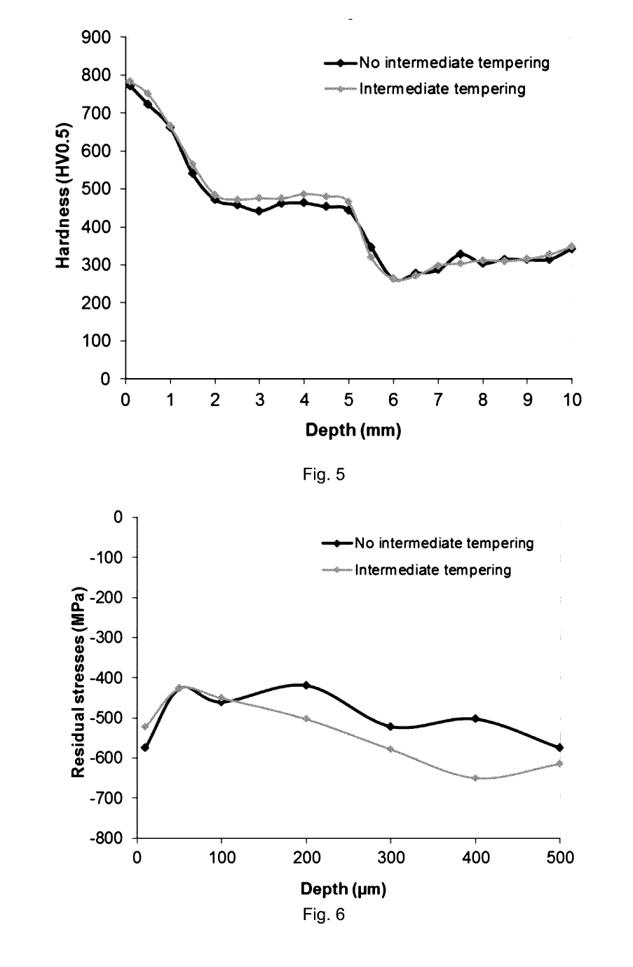

FIGS. 5 and 6 show the effect of intermediate tempering, i.e. a tempering step between steps a) and b) of a method according to the present invention, on the hardness and residual stresses of a metal component subjected to such a method. FIG. 5 shows that the hardness profile of the metal component is not affected by intermediate tempering. However, FIG. 6 shows that intermediate tempering increases the compressive residual stresses from 100-500 μm depth below the surface of the metal component. Such an intermediate tempering step may therefore be carried out if such increased compressive residual stresses are desirable in the finished metal component.

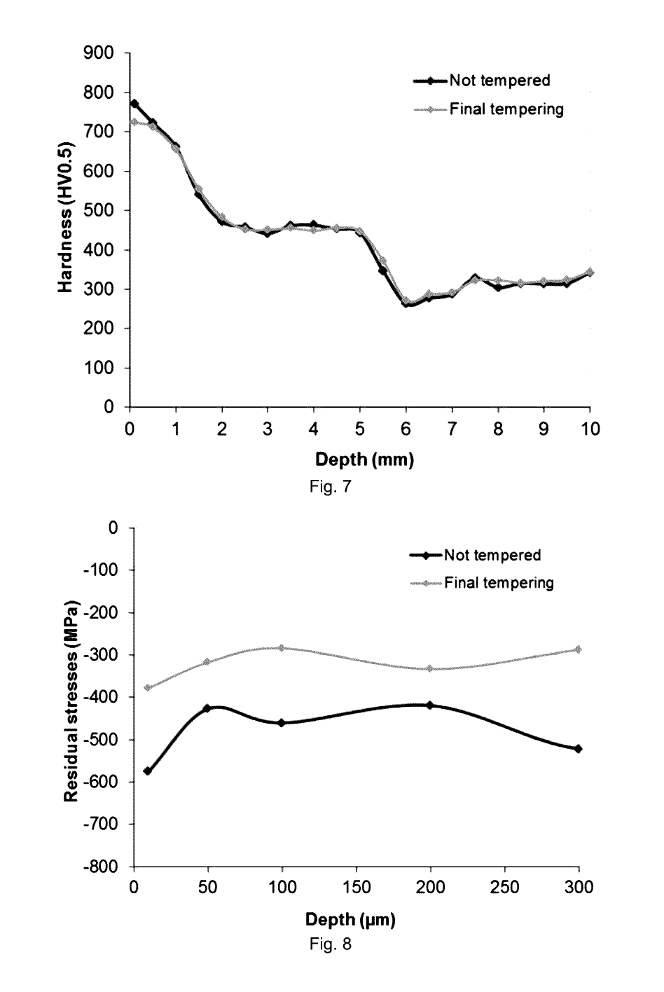

FIGS. 7 and 8 show the effect of final tempering, i.e. a tempering step after steps a) and b) of a method according to the present invention have been carried out, on the hardness and residual stresses of a metal component subjected to a method according to an embodiment of the invention. FIG. 7 shows that final tempering reduces the hardness at a depth of up to 0.5 mm below the surface of the metal component by approximately 50 HV 0.5. FIG. 8 shows that final tempering reduces the compressive residual stresses by 100-200 MPa up to 0.3 mm below the surface of the metal component. Final tempering may therefore be optionally included in an embodiment of the method according to the present invention to obtain a finished metal component having the desired properties depending on the application in which it will be used.

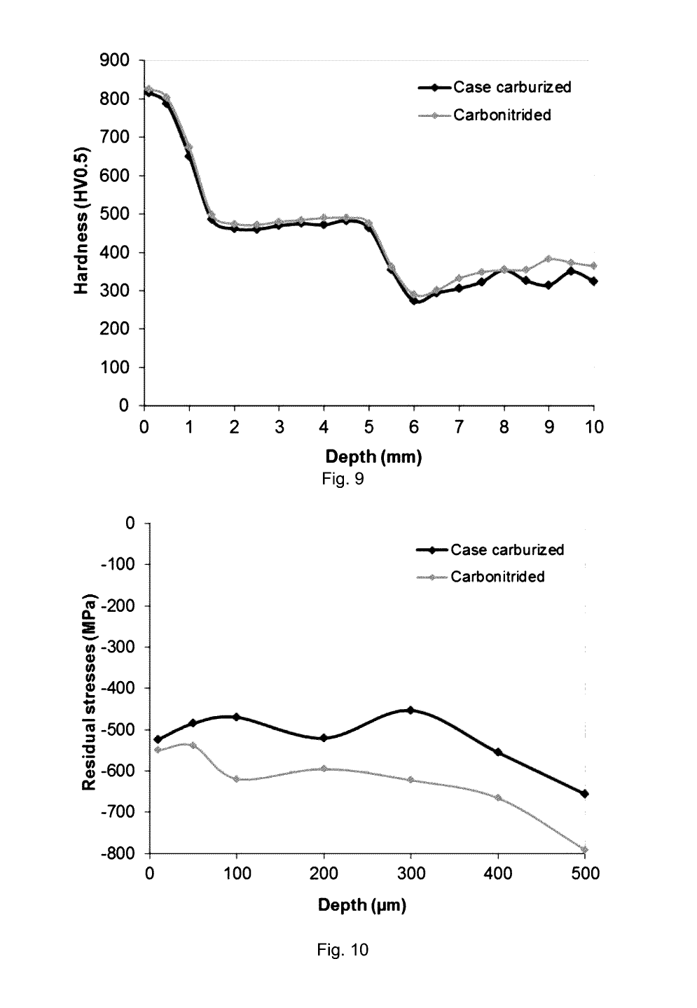

FIGS. 9 and 10 show the effect of using carbonitriding instead of case carburizing in the surface enrichment step a) of a method according to the present invention on the hardness and residual stresses of a metal component subjected to such a method. FIG. 9 shows that case carburizing and carbonitriding provide a metal component with a very similar hardness profile. FIG. 10 shows that carbonitriding provides a metal component having increased compressive stresses up to a depth of 0.5 mm below its surface. Carbonitriding can therefore be used in the surface enrichment step a) of a method according to the present invention if such increased compressive residual stresses are desirable in the finished metal component. Furthermore, using carbonitriding instead of case carburizing in the surface enrichment step a) of a method according to the present invention may slightly increase the corrosion resistance of the metal component due to the introduction of nitrogen into the metal.

According to an embodiment of the present invention the metal component has residual stresses lower than −300 MPa, lower than −400 MPa or lower than −500 MPa at a depth of 0-0.5 mm below its surface after being subjected to the method. The magnitude of residual stresses is strongly dependent on the induction hardening depth. If a smaller induction hardening depth is chosen, low residual stresses, i.e. lower than −300 MPa may be achieved.

Further modifications of the invention within the scope of the claims would be apparent to a skilled person.

1. Method for surface hardening at least one part of a surface of a metal component (10, 12, 14, 16), characterized in that it comprises the steps of a) enriching said at least one part of a surface of a metal component (10, 12, 14, 16) with carbon and/or nitrogen, and b) induction hardening said at least one part of said surface of the metal component (10, 12, 14, 16).

2. Method according to claim 1, characterized in that step a) includes case carburizing or carbonitriding said at least one part of said surface of the metal component (10, 12, 14, 16).

3. Method according to claim 1 or 2, characterized in that it comprises the step of tempering said at least one part of said surface of the metal component (10, 12, 14, 16) in between said surface enrichment step a) and said induction hardening step b).

4. Method according to any of the preceding claims, characterized in that it comprises the step of tempering said at least one part of said surface of the metal component (10, 12, 14, 16) after both of the steps a) and b) have been carried out.

5. Method according to any of the preceding claims, characterized in that it comprises the step of deep cooling said at least one part of said surface of the metal component (10, 12, 14, 16) to below −20° C. after both of the steps a) and b) have been carried out.

6. Method according to any of the preceding claims, characterized in that said surface enrichment step a) is followed by martensitic or bainitic quenching or cooling.

7. Method according to any of the preceding claims, characterized in that said induction hardening step b) is followed by martensitic or bainitic quenching.

8. Method according to any of the preceding claims, characterized in that said metal component (10, 12, 14, 16) constitutes at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength.

9. Method according to any of the preceding claims, characterized in that said metal component (10, 12, 14, 16) comprises steel containing 0.5-5.0 weight-% Cr, 0.1-5.0 weight-% Mo and 0.1-1.1 weight-% C, the remainder being Fe and optionally any one or more of the following Cr, Mo, Si, Ni, and/or V, and normally occurring impurities.

10. Method according to any of the preceding claims, characterized in that said metal component (10, 12, 14, 16) comprises one of the following steels: C56E2, 42CrMo4, 50CrMo4, 20NiCrMo7, 16MnCr5, 18NiCrMo14-6, 18NiCrMo7-6 a high carbon bearing steel grade, such as 100Cr6.

11. Method according to any of the preceding claims, characterized in that said metal component (10, 12, 14, 16) has a case depth up to 1+Dw/30 mm where Dw is the maximum transverse dimension of said metal component (10, 12, 14, 16) in millimetres, a surface carbon content of 0.5-2.5 weight-% and/or a surface nitrogen content of 0-1 weight-%, and an induction hardening depth of up to 1.3*(1+Dw/30) mm after being subjected to said method.

12. Method according to any of the preceding claims, characterized in that said metal component (10, 12, 14, 16) has residual stresses lower than −300 MPa at a depth of 0-0.5 mm below its surface after being subjected to said method.

13. Metal component (10, 12, 14, 16) characterized in that it has a case depth up to 1+Dw/30 mm where Dw is the maximum transverse dimension of said metal component (10, 12, 14, 16) in millimetres, a surface carbon content of 0.5-2.5 weight-% and/or a surface nitrogen content of 0-1 weight-%, and an induction hardening depth of up to 1.3*(1+Dw/30) mm.

14. Metal component (10, 12, 14, 16) according to claim 13, characterized in that it has residual stresses lower than −300 MPa at a depth of 0-0.5 mm below its surface after being subjected to said method.

15. Metal component (10, 12, 14, 16) according to claim 13 or 14, characterized in that it comprises steel containing 0.5-5.0 weight-% Cr, 0.1-5.0 weight-% Mo and 0.1-1.1 weight-% C, the remainder being Fe and optionally any one or more of the following Cr, Mo, Si, Ni, and/or V, and normally occurring impurities.

16. Metal component (10, 12, 14, 16) according to any of claims 13-15, characterized in that it comprises one of the following steels: C56E2, 18CrNiMo7-6, a high carbon bearing steel grade, such as 100Cr6, 42CrMo4, 50CrMo4, 20NiCrMo7, 16MnCr5 or 18NiCrMo14-6.

17. Metal component (10, 12, 14, 16) according to any of claims 13-16, characterized in that it constitutes at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength.
